(19) United States
(12) Patent Application Publication
(10) Pub. No.: US 2005/0077743 A1
(43) Pub. Date: Apr. 14, 2005

(54) Tong assembly

(76) Inventors: Bernd-Georg Pietras, Wedemark (DE); Martin Liess, Seeize (DE)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 10/681,570

(22) Filed: Oct. 8, 2003

(51) Int. Cl. B25J 15/08

(52) U.S. Cl. 294/88

(57) ABSTRACT

A method and apparatus for handling tubulars is provided. In one aspect, a tong assembly is provided with a first tong for engaging a first tubular and a second tong for engaging a second tubular. Preferably, the tong assembly is mounted on a movable frame for moving the tongs to and from the tubulars. In one embodiment, the tong assembly includes a torque member for rotating the first tong. The first tubular may be rotated relative to the second tubular to makeup or breakout the tubulars. In another aspect, each tong may include a first gripping member operatively coupled to a second gripping member to retain a tubular. Each of the gripping members has a jaw for contacting the tubular. In one embodiment, at least one of the jaws is actuatable to apply a gripping force to the tubular.

### BACKGROUND OF THE INVENTION

1. Field of the Invention

The present invention generally relates to a tong assembly for use in making or breaking tubular connections. Particularly, the present invention relates to a tong assembly having adjustable clamping members for retaining tubulars for connection. More particularly still, the present invention relates to a clamping arrangement for a tong.

2. Description of the Related Art

In the construction of oil or gas wells it is usually necessary to construct long drill pipes. Due to the length of these pipes, sections or stands of pipe are progressively added to the pipe string as it is lowered into the well from a drilling platform. In particular, when it is desired to add a section or stand of pipe, the pipe string is usually restrained from falling into the well by applying the slips of a spider located in the floor of the drilling platform. The new section or stand of pipe is then moved from a rack to the well center above the spider. The threaded pin of the section or stand of pipe to be connected is then located over the threaded box of the pipe string in the well and the connection is made up by rotation therebetween. Thereafter, the newly extended pipe string is released from the spider. The whole pipe string is then lowered until the top of the pipe section is adjacent the spider whereupon the slips of the spider are re-applied to maintain the pipe string in the wellbore.

It is common practice to use a tong assembly apply a predetermined torque to the connection in order to make this connection. The tong assembly is typically located on the platform, either on rails, or hung from a derrick on a chain. In order to make up or break out a threaded connection, the tong assembly has a two tong arrangement. An active (or wrenching) tong supplies torque to the section of pipe above the threaded connection, while a passive (or back up) tong supplies a reaction torque below the threaded connection. Particularly, the back up tong clamps the pipe below the threaded connection, and prevents it from rotating. The clamping of the pipe string may be performed mechanically, hydraulically, or pneumatically. The wrenching tong clamps the upper part of the connection and is driven so that it supplies torque for a limited angle.

This power tong arrangement may also be used to make up connections between other tubulars, for example casing and tubing.

In order to make up or break out a connection of a drill pipe or casing, high torque must be supplied over a large angle. This angle is sometimes six times higher than a conventional wrenching tong can supply. In order to overcome this, the wrenching tong must grip and wrench the pipe section several times to tighten or break the threaded connection fully. Due to the high costs associated with the construction of oil and gas wells, time is critical, and the repeated clamping and unclamping of the wrenching tong increases the time needed to attach each new section or stand of tubulars.

Moreover, adjust the jaws of the tong to the diameter of the pipe further increases the length of the process. Generally, the jaws are designed for use with a predetermined tubular size. When the size of the pipe changes, the jaws must be replaced with the appropriate size jaws. Sometimes, the tong itself must be replaced.

Therefore, there is a need for an improved apparatus for making or breaking a tubular connection. Further, there is a need for an apparatus that will quickly adjust to the size of the tubular to be handled. Further still, there is a need for an apparatus that will quickly clamp the tubular and apply the necessary torque to makeup or breakup a tubular connection. There is also a need for an apparatus having a power driven clamping mechanism to grip and apply torque to makeup or breakout a tubular connection.

### SUMMARY OF THE INVENTION

The present invention provides a tubular handling apparatus for connecting and disconnecting tubulars. In one aspect, the apparatus includes a first tong for engaging a first tubular and a second tong for engaging a second tubular. Preferably, the tongs are mounted on a movable frame for moving the tongs to and from the tubulars. In one embodiment, the apparatus includes a torque member for rotating the first tong. In this manner, the first tubular may be rotated relative to the second tubular to makeup or breakout the tubulars.

In another aspect, the present invention provides a gripping apparatus for handling a tubular. The gripping apparatus is adapted to quickly adjust to the size of the tubular to be handled. The gripping apparatus comprises a first gripping member operatively coupled to a second gripping member to retain the tubular. Each of the gripping members has a jaw for contacting the tubular. In one embodiment, at least one of the jaws is actuatable to apply a gripping force to the tubular.

In another aspect, the gripping apparatus includes an actuator to cause the first and second gripping members to engage the tubular. In one embodiment, the actuator comprises a spindle. The first gripping member is operatively coupled to the spindle using a nut. Rotation of the spindle causes the nut to move along the threads of the spindle, thereby moving the first gripping member relative to the second gripping member. In another embodiment, the actuator comprises a piston and cylinder assembly.

In another aspect, the gripping apparatus includes features adapted to resist elastic deformation. In one embodiment, the loading bearing components are provided with spherical bearings or cylindrical bearings. In another embodiment, one or more force distributors are used to distribute torque acting on the gripping members to the housing of the gripping apparatus.

The presenting invention also provides a method for handling a tubular. The method includes providing a first gripping member having a first jaw and a second gripping member having a second jaw. The gripping members are actuated to engage the tubular. Thereafter, the second jaw is actuated to apply a gripping pressure.

In another aspect still, the present invention provides a method for connecting a first tubular to a second tubular. The method includes providing a first tong and a second tong, the first tong rotatable relative to the second tong. Initially, the second tong is caused to engage the second tubular. The first tong is rotated relative to the second tong into position to engage the first tubular. After the first tong engages the first tubular, the first tong is rotated to connect the tubulars.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an embodiment of the tong assembly according to aspects of the present invention. The tong assembly is shown the unactuated position.

FIG. 2 shows the backup tong with a portion of its housing removed for clarity.

FIG. 3 is a cross-sectional view of the wrenching tong.

FIG. 4 depicts the wrenching tong with a portion of its housing removed for clarity.

FIG. 5 illustrates the backup tong in engagement with a tubular.

FIG. 6 shows the wrenching tong rotated relative to the backup tong. Additionally, the wrenching tong is engaged with a tubular.

FIG. 7 shows the wrenching cylinder partially retracted, and the wrenching tong partially rotated back into alignment with the backup tong.

### DETAILED DESCRIPTION OF THE PREFERRED EMBODIMENT

The present invention relates to a tong assembly for making up and breaking out a tubular connection. The tong assembly includes a power tong and a backup tong 40 to apply torque the tubular connection. Each tong includes a powered gripping arrangement to apply a gripping force to the tubular.

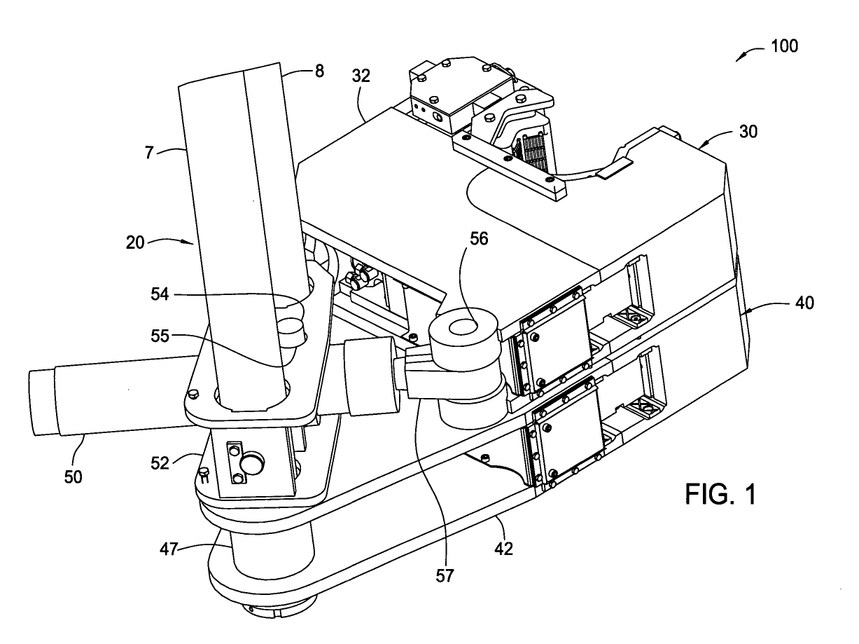

FIG. 1 illustrates an embodiment of the tong assembly 100 according to aspects of the present invention. The tong assembly 100 is held above the wellbore by a movable frame 20. The frame 20 includes a pair of columns 7, 8 for attachment to the tong assembly 100. The movable frame 20 may include moving mechanisms such as wheels, rails, cables, or combinations thereof. The movable frame 20 may be used to move the tong assembly 100 to and from the tubulars.

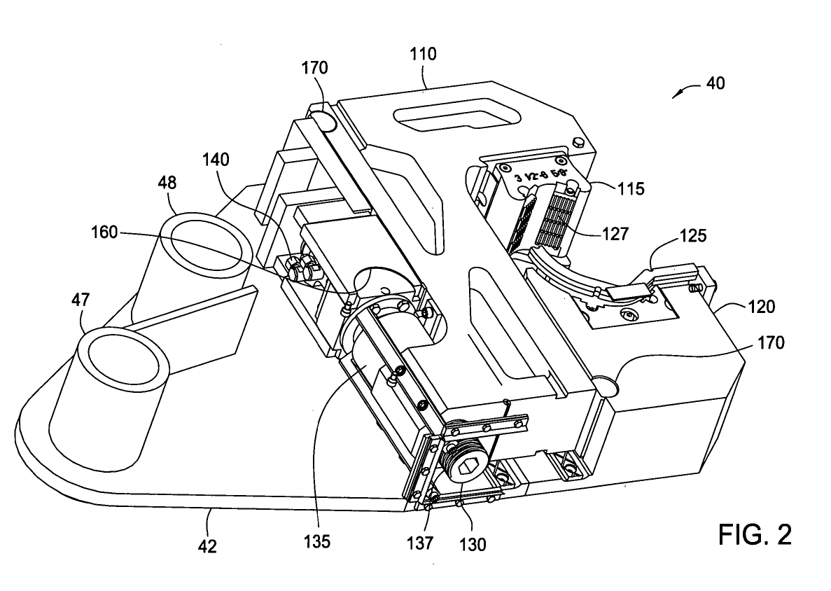

In one aspect, the tong assembly 100 includes a wrenching tong 30 and a backup tong 40. As shown, the frame 20 is connected to the housing 42 of the backup tong 40. The wrenching tong 30 is disposed above the backup tong 40. The housing 32 of the wrenching tong 30 is designed to allow the frame 20 to be attached to the backup tong 40. As shown in FIG. 1, the housing 32 of wrenching tong 30 is partially truncated in comparison to the housing 42 of the backup tong 40. FIG. 2 shows the backup tong 40 with a portion of its housing 42 removed. It can be seen that the backup tong 40 includes a pair of column supports 47, 48 for connection with the columns 7, 8 of the frame 20.

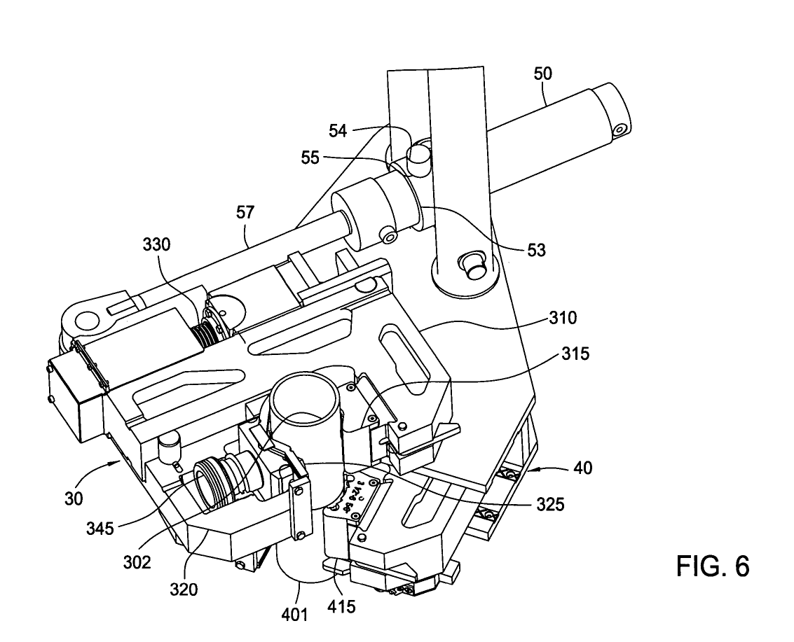

Referring back to FIG. 1, a wrenching cylinder 50 is used to apply torque to the wrenching tong 30. The wrenching cylinder 50 is mounted to the frame 20 using a cylinder support member 52. Particularly, the wrenching cylinder 50 is pivotably connected to the frame 20 and the wrenching tong 30. In one embodiment, a pivotable mechanism connecting the wrenching cylinder 50 to the frame 20 includes a collar 53 disposed around the wrenching cylinder 50, as illustrated in FIG. 6. The collar 53 having an indexing member 54 extending through an indexing opening 55 in the cylinder support member 52. The pivotable mechanism allows the wrenching cylinder 50 to pivot relative to the frame 20 as it rotates the wrenching tong 30. Additionally, a second pivotable mechanism is used to connect the wrenching cylinder 50 to the wrenching tong 3Q. In one embodiment, the second pivotable mechanism includes a pin 56 in the housing 32 of the wrenching tong 30 inserted through the piston 57 of the wrenching cylinder 50. The pivotable mechanisms work together to provide rotational movement to the wrenching tong 30. Preferably, the center of rotation of the wrenching tong 30 shares the same or substantially the same center of the tubular connection. In one aspect, the wrenching cylinder 50 may rotate the wrenching tong 30 for an angle up to about 40 degrees relative to the backup tong 40, more preferably, up to about 35 degrees, and most preferably, up to about 30 degrees. Torque is applied to the tubular connection when the wrenching tong 30 is rotated by the wrenching cylinder 50. The wrenching cylinder 50 may be actuated hydraulically, pneumatically, mechanically, or combinations thereof. The applied torque is proportional to the pressure of the wrenching cylinder 50. It must be noted that other suitable pivotable mechanisms may be used as is known to a person of ordinary skill in the art.

In another aspect, the tongs 30, 40 of the tong assembly 100 include a novel gripping arrangement or clamping system for retaining a tubular. In the embodiment shown in FIG. 1, both the wrenching tong 30 and the backup tong 40 are equipped with the same clamping system. Therefore, the discussions herein with respect to the clamping system apply to both tongs 30, 40, unless otherwise indicated.

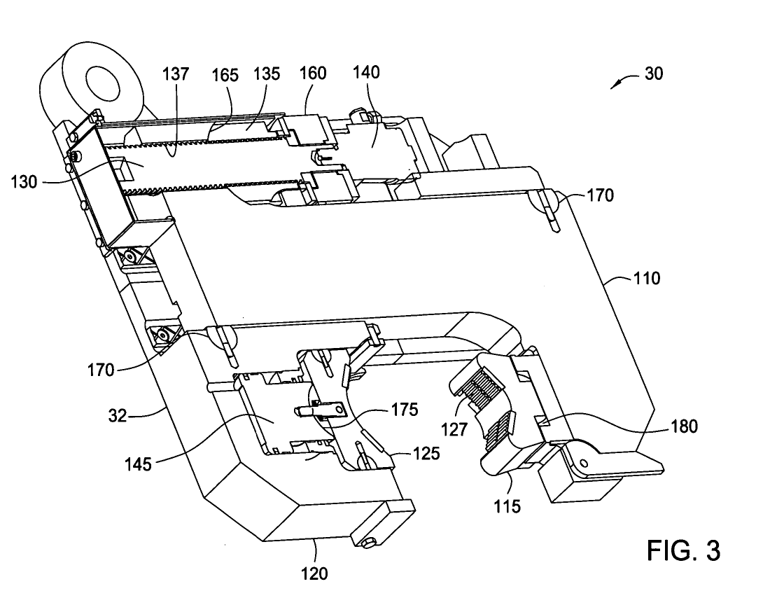

Referring to FIG. 2, the clamping system or gripping arrangement includes an active clamping member 110 operatively coupled to a passive clamping member 120. The active clamping member 110 is movably disposed in the housing 42, and the passive clamping member 120 is fixed to the housing 42. Each clamping member 110, 120 is provided with a gripping member, such as a jaw 115, 125, adapted to engage a tubular. The clamping members 110, 120 are arranged such that actuation of the active clamping member 110 will move the jaw 115 of the active clamping member 110 closer to the jaw 125 of the passive clamping member 120, thereby engaging the tubular. The clamping arrangement can also be seen in FIG. 3, which is a cross-sectional view of the wrenching tong 30.

In one embodiment, a spindle 130 is used to actuate the active clamping member 110. Referring to FIGS. 2 and 3, the spindle 130 is threadedly coupled to a nut 135 attached to the active clamping member 110. The spindle 130 is actuated by a hydraulic motor 140. During operation, the positions of the spindle 130 and the motor 140 remain stationary relative to the housing 42. As the spindle 130 is rotated by the motor 140, the nut 135 moves along the threads 137 of the spindle 130, thereby moving the active clamping member 110 relative to the passive clamping member 120. In another embodiment, the active clamping member 110 may be actuated by a piston and cylinder assembly. Extension or retraction of the cylinder assembly will result in a corresponding movement of the active clamping member 110.

In one aspect, the tong body is adapted to handle various tubular sizes. Unlike conventional tongs, the tong according to aspects of the present invention may change its body size to handle different size tubulars. Particularly, the tong body includes an active clamping member 110 operatively coupled to a passive clamping member 120. During operation, the active clamping member 110 may be adjusted relative to the passive clamping member 120 to accommodate the new tubular, or to approximate the diameter of the new tubular. In this respect, the overall body size of the tong is changed.

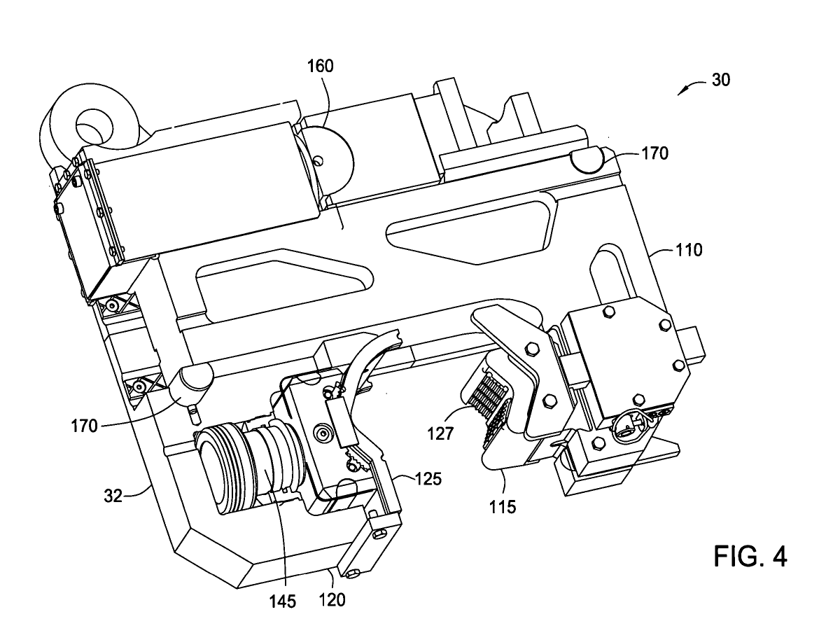

After the clamping members 110, 120 bring the jaws 115, 125 into engagement with the tubular, the jaws 115, 125 may be actuated to apply the clamping pressure on the tubular. FIG. 4 depicts the wrenching tong 30 with a portion of its housing 32 removed. A clamping cylinder 145 may be seen coupled to the jaw 125 on the passive clamping member 120. In this respect, this jaw 125 is also known as the active jaw 125 and may be actuated by a clamping cylinder 145 to apply the clamping force. The jaw 115 on the active clamping member 110, also known as the passive jaw 115, cooperates with the active jaw 125 to engage the tubular. It is also contemplated that either or both jaws may be an active jaw or a passive jaw. It is further contemplated that the clamping cylinder may be actuated hydraulically, pneumatically, mechanically, or combinations thereof without deviating from the aspects of the present invention.

To further facilitate engagement with the tubular, one or more dies 127 may be mounted on the jaws 115, 125. The dies 127 may be replaced as necessary without replacing the jaws 115, 125. Typically, the dies 127 are replaced when worn, or when the characteristics of the tubular changes. In another embodiment, teeth may be formed directly on the jaws 115, 125 to facilitate engagement.

In another aspect, the load bearing components in the tongs 30, 40 of the present invention may be adapted to withstand the forces necessary to makeup or breakout the tubular connection. It is believed that due to these forces, the clamping system may, in some instances, elastically deform. To reduce the potential for elastic deformation, the clamping system of the present invention includes features which assist in resisting deformation. In one embodiment, the spindle 130 is fitted with a cylindrical bearing 160, as shown in FIG. 2. Also, a spherical contact surface 165 is provided between the nut 135 and the active clamping member 110, as shown in FIG. 3. The cylindrical bearing 160 or the spherical contact surface 165 may act to reduce the potential for the spindle 130 to bend.

In another embodiment, the active clamping member 110 is in contact with the housing 32, 42 through one or more force distributors. Particularly, the force distributor comprises a pendulum bolt 170 having a flat surface on one end and an arcuate surface on another end. As shown in FIGS. 2 and 4, each tong 30, 40 is equipped with two pendulum bolts 170. The pendulum bolts 170 are disposed between the active clamping member 110 and the housing 32, 42. When the active clamping member 110 encounters a torque, the torque is transferred to the pendulum bolts 170, which in turn, distributes the torque to the housing 32, 42. Further, the pendulum bolts 170 are also self aligning. In this respect, the forces may be transferred through a maximum contact area.

Similarly, the jaws 115, 125 also have features to resist deformation. In one embodiment, the clamping cylinder 145 is in contact with the active jaw 125 through a spherical bearing 175, as illustrated in FIG. 3. In this respect, the piston of the clamping cylinder 145 is protected. In another embodiment, a spherical bearing 180 is disposed between the passive jaw 115 and the active clamping member 110. The spherical bearing 180 protects the passive jaw 115 and aligns the passive jaw 115 to the tubular surface.

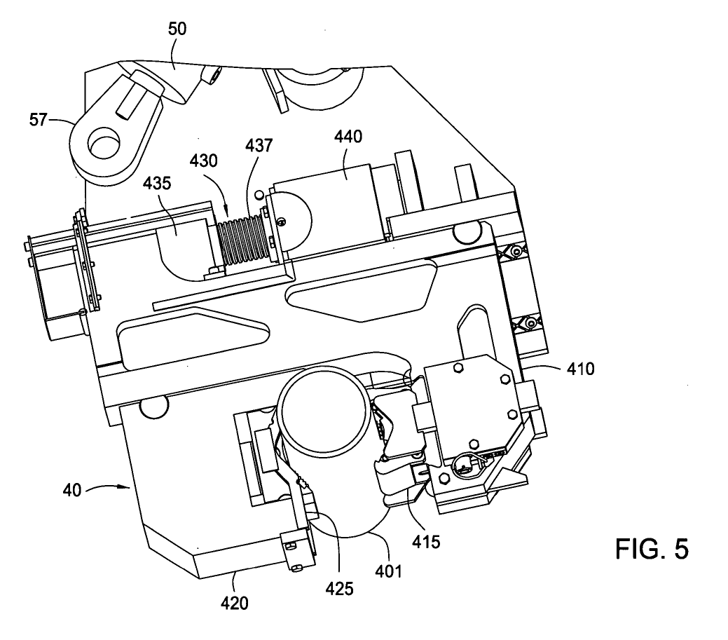

In operation, the tong assembly 100 may be used to connect a first tubular 401 to a second tubular 302. Initially, the tongs 30, 40 are aligned and open to receive the tubulars 401, 302, as illustrated in FIG. 1. The frame 20 is then moved to position the jaws 315, 325, 415, 425 around the tubulars 401, 302 to be connected, as shown in FIGS. 5-7. Preferably, the jaws 415, 425 of the backup tong 40 are positioned to engage the first tubular 401, and the jaws 315, 325 of the wrenching tong 30 are positioned around the second tubular 302.

After the tongs 30, 40 are placed into position, the active clamping member 410 of the backup tong 40 is actuated to move the jaws 415, 425 into engagement with the first tubular 401. Particularly, the motor 440 is actuated to rotate the spindle 430, thereby causing the nut 435 to move along the threads 437 of the spindle 430. As a result, the jaws 415, 425 are moved into engagement with the first tubular 401. FIG. 5 illustrates the backup tong 40 in engagement with the first tubular 401. It can be seen that the nut 435 has moved along the spindle 430, thereby exposing a threaded portion 437 of the spindle 430. After the first tubular 401 is engaged, the clamping cylinder of the active jaw 425 is actuated to apply the proper gripping force against the first tubular 401.

Thereafter, the wrenching cylinder 50 is actuated to rotate the wrenching tong 30 about the center of the second tubular 302. As shown in FIG. 6, actuation of the wrenching cylinder 50 extends the piston away from the cylinder support member 52 and rotates the wrenching tong 30 relative to the backup tong 40. During actuation of the wrenching cylinder 50, it is preferred that a spinner is used to partially makeup the tubulars 401, 302. Generally, spinners are capable of quickly making up the connection at low torque but high speed. The spinner may optionally be disposed on the frame 20 to partially makeup the connection while the piston 57 of the wrenching cylinder 50 is extended. In this manner, valuable time can be saved.

After the piston 57 is extended, the active clamping member 310 of the wrenching tong 30 is actuated. The spindle 330 is rotated to cause the active clamping member 310 to move the jaws 315, 325 into engagement with the second tubular 302. Then, the clamping cylinder 345 is actuated to apply the proper gripping force to the jaws 315, 325. In FIG. 6, the wrenching tong 30 is shown engaged with the second tubular 302. In addition, the wrenching tong 30 has been rotated about 30 degrees relative to the backup tong 40.

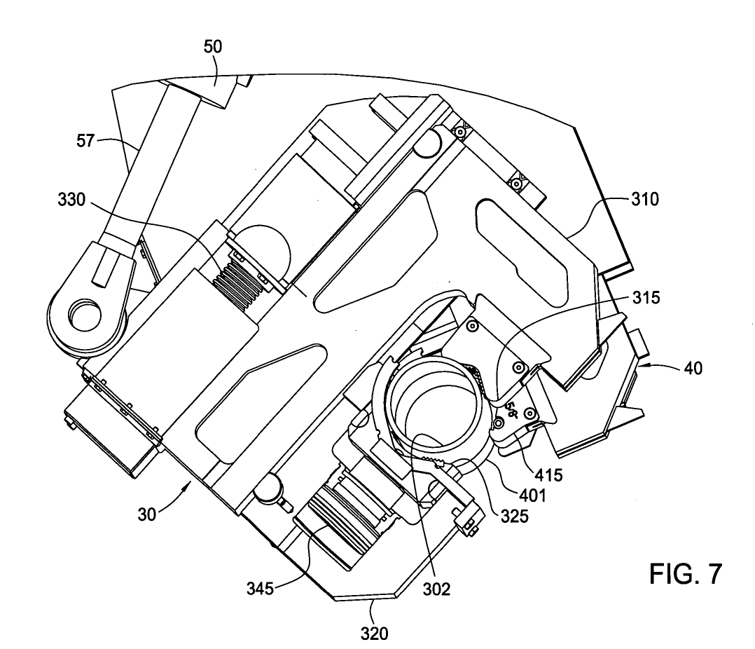

Torque may now be applied to makeup the connection. Torque is supplied by the wrenching cylinder 50 by retracting the piston 57. Retraction of the piston 57 causes the wrenching tong 30 to rotate, thereby rotating the second tubular 302 relative to the first tubular 401. FIG. 7 shows the piston 57 partially retracted and the wrenching tong 30 partially rotated back into alignment with the backup tong 40. Thereafter, the spindle 330 may be actuated to move the active clamping member 310 back to the open position. If necessary, the process may be repeated for the active clamping member 310 to fully makeup the tubular connection.

The tong assembly 100 may also be used to disconnect tubulars 401, 302. After the backup tong 40 has engaged the first tubular 401, the active clamping member 310 of the wrenching tong 30 may be actuated to move the jaws 315, 325 into engagement with the second tubular 302. The active jaw 325 is then actuated to apply the gripping force. Thereafter, the piston 57 is extended to rotate the wrenching tong 30. In turn, the second tubular 302 is rotated relative to the first tubular 401 to be disconnected therefrom.

The tong according to aspects of the present invention may optionally be remotely operated. In one aspect, the movement of the components of the tong may be operated from a remotely placed control panel. In another aspect, the tong may be configured to perform the tubular make up or break up process autonomously, e.g. in accordance with a computer program. Particularly, the tong may include any suitable interface for performing the process.

In another aspect still, the tong may include one or more sensors to facilitate its operation. In one embodiment, the tong may include proximity sensors to determine the location of the tubular. In another embodiment, the tong may include sensors for determining the torque or force applied. Additional sensors may be included as is known to a person of ordinary skill in the art.

While the foregoing is directed to embodiments of the present invention, other and further embodiments of the invention may be devised without departing from the basic scope thereof, and the scope thereof is determined by the claims that follow.

1. An apparatus for handling a tubular, comprising:
a first gripping member operatively coupled to a second gripping member to retain the tubular;
the first gripping member including a first jaw; and
the second gripping member including a second jaw, wherein at least one of the jaws is actuatable to apply a force to the tubular.

2. The apparatus of claim 1, further comprising an actuator to cause the first and second gripping members to engage the tubular.

3. The apparatus of claim 2, wherein the actuator comprises a piston and cylinder assembly.

4. The apparatus of claim 2, wherein the actuator comprises a spindle.

5. The apparatus of claim 4, wherein rotating the spindle moves the first gripping member relative to the second gripping member.

6. The apparatus of claim 2, wherein the actuator is adapted to resist elastic deformation.

7. The apparatus of claim 6, wherein the actuator includes one or more cylindrical bearing.

8. The apparatus of claim 6, wherein the actuator includes one or more arcuate contact surfaces.

9. The apparatus of claim 2, wherein the force is applied by a cylinder.

10. The apparatus of claim 2, wherein at least one of the first and second jaws includes a spherical bearing.

11. The apparatus of claim 2, further comprising one or more force distributors.

12. The apparatus of claim 1, wherein the second jaw includes a hydraulic cylinder.

13. The apparatus of claim 1, wherein at least one of the first and second jaws includes a spherical bearing.

14. The apparatus of claim 1, further comprising one or more force distributors.

15. A tubular handling assembly, comprising:
a first tubular handling member;
a second tubular handling member; and
a torque member for applying torque to the second tubular handling member,
wherein at least one of the tubular handling members includes:
a first gripping member operatively coupled to a second gripping member to retain the tubular;
the first gripping member having a first jaw; and
the second gripping member having a second jaw, wherein at least one of the jaws is actuatable to apply a force to the tubular.

16. The tubular handling assembly of claim 15, further comprising an actuator to cause the first and second gripping members to engage the tubular.

17. The tubular handling assembly of claim 16, wherein the actuator comprises a spindle.

18. The tubular handling assembly of claim 17, wherein rotating the spindle moves the first gripping member relative to the second gripping member.

19. The tubular handling assembly of claim 16, wherein the actuator is adapted to resist elastic deformation.

20. The tubular handling assembly of claim 16, wherein the force is applied by a cylinder.

21. The tubular handling assembly of claim 20, wherein the actuator comprises a spindle.

22. The tubular handling assembly of claim 16, wherein the torque member comprises a hydraulic cylinder.

23. The tubular handling assembly of claim 15, wherein at least one of the first and second jaws includes a spherical bearing.

24. The tubular handling assembly of claim 15, further comprising one or more force distributors.

25. A method for handling a tubular, comprising:
providing a first gripping member having a first jaw;
providing a second gripping member having a second jaw;
engaging the tubular between the first jaw and the second jaw; and
actuating the second jaw to apply a gripping pressure.

26. The method of claim 25, moving the first gripping member relative to the second gripping member to engage the tubular.

27. The method of claim 26, wherein a spindle is rotated to move the first gripping member.

28. The method of claim 26, wherein a hydraulic cylinder is activated to move the first gripping member.

29. The method of claim 25, wherein a hydraulic cylinder is used to actuate the second jaw.

30. A method for connecting a first tubular to a second tubular, comprising:
providing a first tong and a second tong, the first tong rotatable relative to the second tong;
engaging the second tubular with second tong;
rotating the first tong relative to the second tong;
engaging the first tubular with the first tong; and
rotating the first tubular relative to the second tubular to connect the tubulars.

31. The method of claim 30, further comprising:
applying a gripping force to the second tubular after engagement.

32. The method of claim 30, further comprising rotating a spindle to cause the second tubular to engage the second tubular with the second tong.

33. An apparatus for handling a tubular, comprising:
an adjustable tong, including:
a first body part operatively coupled to a second body part, wherein the first body part is movable relative to the second body part to approximate a diameter of a tubular;
the first body part having a first jaw;
the second body part having a second jaw,
wherein the first body part moves the first jaw into contact with the tubular, thereby engaging tubular with the first jaw and the second jaw.

34. A method of handling a tubular with a tong, comprising:
providing an adjustable tong having a plurality of jaws;
adjusting the tong to proximate a diameter of the tubular;
engaging the tubular with the plurality of jaws; and
applying a gripping force with the plurality of jaws.

35. The method of claim 34, further comprising remotely operating the tong.

36. The method of claim 34, further comprising automating the tong.

37. The method of claim 34, further comprising providing one or more sensors.
